(19) United States
(12) Patent Application Publication
(10) Pub. No.: US 2014/0353458 A1
(43) Pub. Date: Dec. 4, 2014

(54) SHOCK ISOLATION CAGE

(71) Applicants: Inventec Corporation, Taipei City (TW); Inventec (Pudong) Technology Corporation, Shanghai (CN)

(72) Inventors: Chung-Chien WU, TAIPEI CITY (TW); Hung-Jung HSIA, TAIPEI CITY (TW)

(73) Assignees: Inventec Corporation, Taipei City (TW); Inventec (Pudong) Technology Corporation, Shanghai (CN)

(21) Appl. No.: 14/184,681

(22) Filed: Feb. 19, 2014

(30) Foreign Application Priority Data
May 28, 2013 (CN) 201310203053.9

(51) Int. Cl. G11B 33/08; G11B 33/12

(52) U.S. Cl. CPC G11B 33/08; G11B 33/128
USPC 248/581

(57) ABSTRACT

A shock isolation cage including a bottom plate, two side plates, a top plate, and two shock isolation members is provided. Each of the side plates is fixed to the bottom plate. The top plate is fixed to the side plates. The bottom plate, the side plates, and the top plate surround to form an accommodating space for accommodating an electronic apparatus. Each of the shock isolation members includes a main body, a first shock isolation portion, and a second shock isolation portion. The main body is fixed to the corresponding side plate. The first and second shock isolation portions are connected to the main body, and respectively contact the bottom surface and the top surface of the electronic apparatus.

### RELATED APPLICATIONS

This application claims priority to Chinese Application Serial Number 201310203053.9, filed May 28, 2013, which is herein incorporated by reference.

### BACKGROUND

1. Technical Field

The present disclosure relates to a shock isolation cage.

2. Description of Related Art

The basic structure of a server is substantially the same as that of a personal computer. The server is constituted of components such as a CPU (Central Processing Unit), memories, I/O equipment, etc. The components are connected in the server by buses. The CPU and the memories are connected by a Northbridge chipset, and the I/O equipment is connected by a Southbridge chipset.

Taking a rack server as an example, the rack server is a kind of server that complies with a united standard design and is used together with a rack. Therefore, the rack server can be deemed as an optimized server, and one of the purposes of the design of the rack server is to reduce the space occupied by the rack server as possible. There are also many professional network apparatuses adopt rack structures, and most of them are flat, such as drawers.

In general, the main board in the rack server is slidably disposed in the chassis of the rack server. Hence, data storage devices can be carried by carrier brackets and installed on the rack based on the same concept. As a result, the rack can accommodate more data storage devices.

However, there is no shock isolation mechanism designed among the present rack and the carrier brackets. Moreover, because storage devices almost need to support hot-swapping, there must remain a gap between the rack and each of the carrier brackets. Therefore, under the vibration environment, the collisions among the rack and the carrier brackets may worsen the performance of the storage devices, and the storage devices may be seriously damaged after being impacted.

### SUMMARY

The disclosure provides a shock isolation cage. The shock isolation cage is configured to accommodate an electronic apparatus. The shock isolation cage includes a bottom plate, two side plates, a top plate, and two shock isolation members. The side plates are fixed to the bottom plate. The top plate is fixed to the side plates to make the side plates be located between the bottom plate and the top plate. The bottom plate, the side plates, and the top plate surround to form an accommodating space. The shock isolation members are respectively fixed to the side plates. Each of the shock isolation members includes a main body, a first shock isolation portion, and a second shock isolation portion. The main body is fixed to the corresponding side plate. The first shock isolation portion is connected to the main body and capable of contacting a bottom surface of the electronic apparatus. The second shock isolation portion is connected to the main body and capable of contacting a top surface of the electronic apparatus.

In an embodiment of the disclosure, the electronic apparatus includes a carrier bracket. The carrier bracket includes two sidewall portions. Each of the side plates has a first passing portion and a second passing portion. The first and second shock isolation portions pass into the accommodating space respectively via the corresponding first and second passing portions. When the carrier bracket is inserted into the accommodating space, each of sidewall portions of the carrier bracket is clamped and fixed between the corresponding first and second shock isolation portions.

In an embodiment of the disclosure, the first and second passing portions of each of the side plates are formed along a first direction away from the bottom plate.

In an embodiment of the disclosure, the first shock isolation portion has a first surface and a first chamfer. The first surface faces toward the second isolation portion. The first chamfer is formed on the first surface along a second direction parallel to the bottom plate. The second shock isolation portion has a second surface and a second chamfer. The second surface faces toward the first shock isolation portion. The second chamfer is formed on the second surface along the second direction. During the period that the carrier bracket is inserted into the accommodating space along the second direction, each of the sidewall portions is guided by the corresponding first and second chamfers to pass through the corresponding first and second shock isolation portions.

In an embodiment of the disclosure, each of the side plates further has a third passing portion. The first passing portion, the second passing portion, and the third passing portion of each of the side plates are sequentially formed along the first direction. Each of the shock isolation members further includes a third shock isolation portion. The third shock isolation portion is connected to the main body and passes into the accommodating space via the corresponding third passing portion. When the carrier bracket is inserted into the accommodating space, each of the sidewall portions is selectively clamped and fixed between the corresponding first and second shock isolation portions, or between the corresponding second and third shock isolation portions.

In an embodiment of the disclosure, each of the side plates includes at least one guiding portion located in the accommodating space. Each of the guiding portions and the adjacent second shock isolation portion are arranged side by side along a second direction parallel to the bottom plate. During the period that the carrier bracket is inserted into the accommodating space, each of the sidewall portions is guided by the corresponding guiding portion and the corresponding second shock isolation portion, so that the carrier bracket moves relative to the bottom plate along the second direction.

In an embodiment of the disclosure, each of the guiding portions is substantially cylindrical.

In an embodiment of the disclosure, the first shock isolation portion has a first surface and a first chamfer. The first surface faces toward the second shock isolation portion. The first chamfer is formed on the first surface along a second direction parallel to the bottom plate. The second shock isolation portion has a second surface, a second chamfer, a third surface, and a third chamfer. The second surface faces toward the first shock isolation portion. The second chamfer is formed on the second surface along the second direction. The third surface faces toward the third shock isolation portion. The third chamfer is formed on the third surface along the second direction. The third shock isolation portion has a fourth surface and a fourth chamfer. The fourth surface faces toward the second shock isolation portion. The fourth chamfer is formed on the fourth surface along the second direction. During the period that the carrier bracket is inserted into the accommodating space along the second direction, each of the sidewall portions is selectively guided by the corresponding first and second chamfers to pass through the corresponding first and second shock isolation portions, or is guided by the corresponding third and fourth chamfers to pass through the corresponding second and third shock isolation portions.

In an embodiment of the disclosure, the shock isolation member is substantially E-shaped.

Accordingly, by using the shock isolation members disposed at two side plates of the shock isolation cage, the shock isolation cage of the disclosure can achieve the purpose of clamping and fixing the sidewall portions of the carrier bracket. Hence, the vibration isolation effect of the storage devices in the shock isolation cage can be improved. That is, the possibility that the performance of the storage device is worsened by the collisions among the rack and the carrier bracket under the vibration environment can be reduced, and the situation that the storage device is seriously damaged by impacts can be avoided. In addition, the shock isolation cage of the disclosure includes at least three shock isolation portions, and the carrier bracket can be selectively clamped and fixed between any two adjacent shock isolation portions, so that the shock isolation cage is applicable to accommodate a plurality of the stacked storage devices. Moreover, each of the shock isolation portions has a chamfered structure, so that the carrier bracket is guided by the chamfered structures of the shock isolation portions during the period that the carrier bracket is inserted into the shock isolation cage, and thus the smoothness of inserting the carrier bracket into the shock isolation cage can be improved.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a partial perspective view of a server according to an embodiment of the disclosure;

FIG. 2 is a partial exploded view of the server in FIG. 1, in which a top plate is removed;

FIG. 3 is an exploded view of side plates and shock isolation members in FIG. 2;

FIG. 4 is a cross-sectional view of the server in FIG. 1 along line 4-4′;

FIG. 5A is an enlarged view of one of the shock isolation members in FIG. 4; and

FIG. 5B is another enlarged view of the shock isolation members in FIG. 5.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

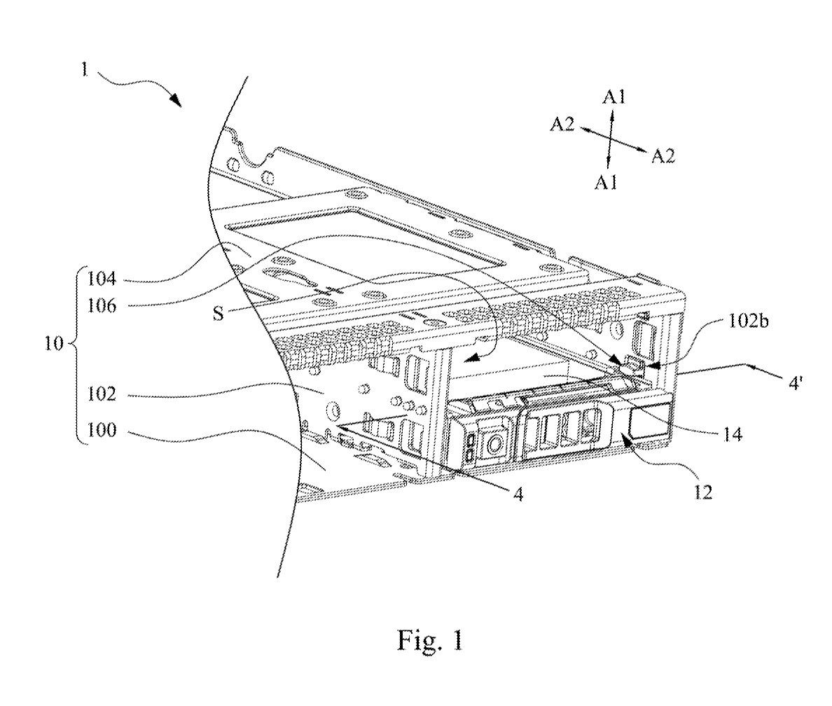

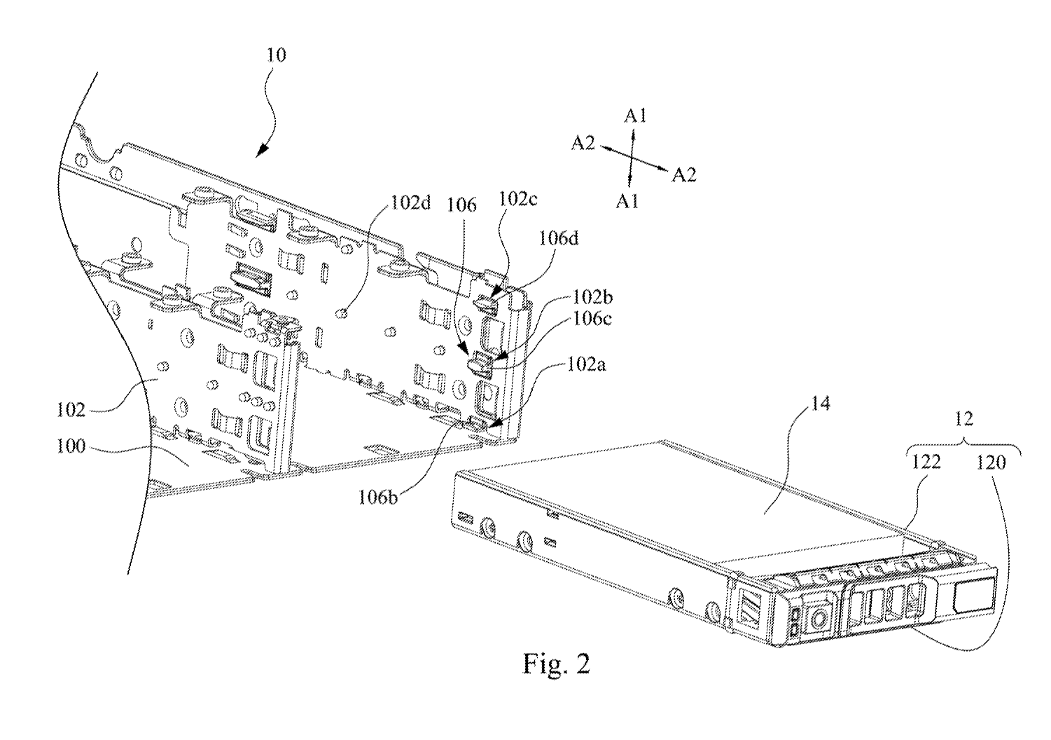

FIG. 1 is a partial perspective view of a server 1 according to an embodiment of the disclosure. FIG. 2 is a partial exploded view of the server 1 in FIG. 1, in which a top plate 104 is removed.

As shown in FIG. 1 and FIG. 2, the server 1 includes a shock isolation cage 10 and an electronic apparatus. The electronic apparatus includes a carrier bracket 12 and a storage device 14. The shock isolation cage 10 of the server 1 includes a bottom plate 100, two side plates 102, a top plate 104, and two shock isolation members 106. The side plates 102 of the shock isolation cage 10 are parallel to each other and separately fixed to the bottom plate 100. Each of the side plates 102 of the shock isolation cage 10 has a first passing portion 102a, a second passing portion 102b, and a third passing portion 102c. The heights of the first passing portions 102a of the side plates 102 relative to the bottom plate 100 are the same, the heights of the second passing portions 102b of the side plates 102 relative to the bottom plate 100 are the same, and the heights of the third passing portions 102c of the side plates 102 relative to the bottom plate 100 are the same. The top plate 104 of the shock isolation cage 10 is fixed to the side plates 102, so that the side plates 102 are located between the bottom plate 100 and the top plate 104, and the top plate 104 is parallel to the bottom plate 100. The bottom plate 100, the side plates 102, and the top plate 104 of the shock isolation cage 10 surround to form an accommodating space S.

In addition, the carrier bracket 12 of the server 1 is detachably accommodated in the accommodating space S. The carrier bracket 12 of the server 1 includes a carrier portion 120 and two sidewall portions 122. The sidewall portions 122 of the carrier bracket 12 are fixed to the carrier portion 120. The storage device 14 of the server 1 is carried on the carrier portion 120 of the carrier bracket 12, and is clamped and fixed between the sidewall portions 122. Therefore, the carrier bracket 12 can protect the storage device 14 of the server 1, and the carrier bracket 12 can be a carrier for moving the storage device 14 and assembling/disassembling the storage device 14 relative to the shock isolation cage 10.

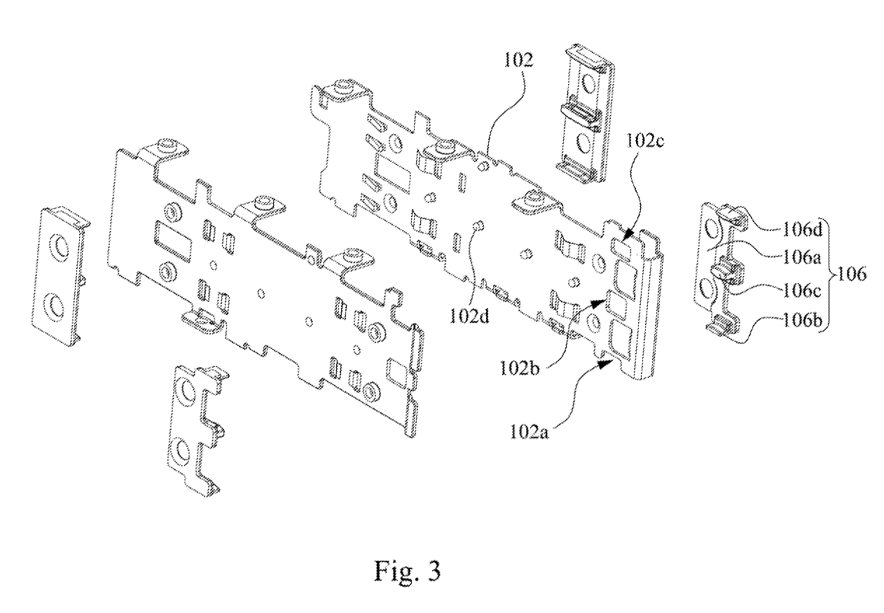

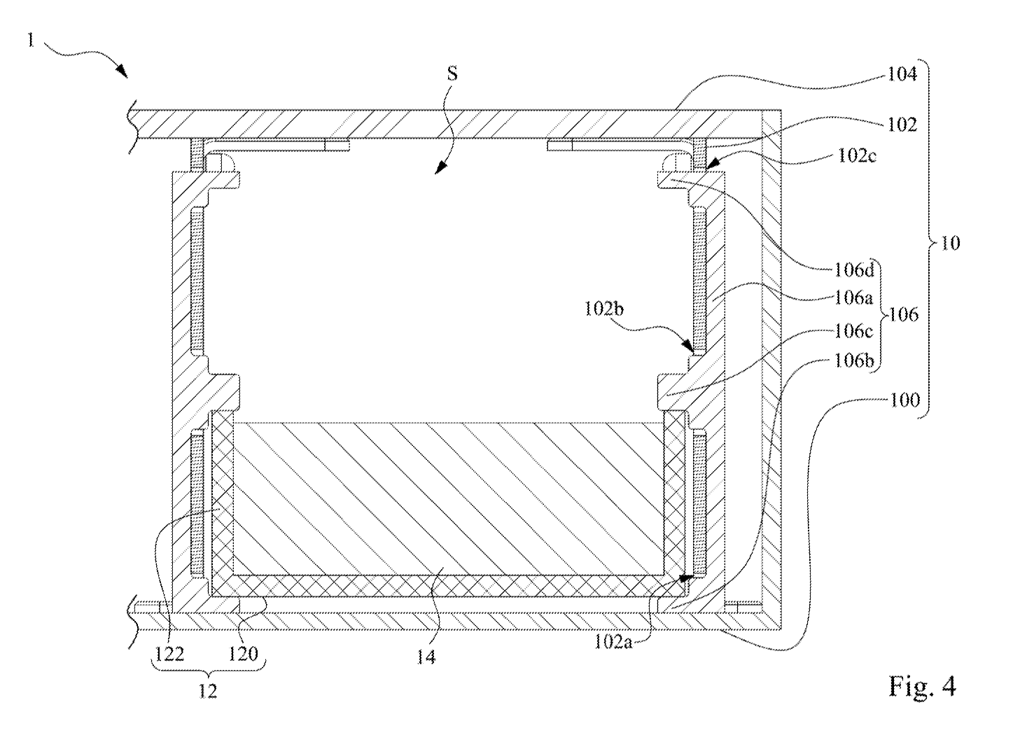

FIG. 3 is an exploded view of the side plates 102 and the shock isolation members 106 in FIG. 2. FIG. 4 is across-sectional view of the server 1 in FIG. 1 along line 4-4′.

As shown in FIG. 3 and FIG. 4, the shock isolation members 106 of the shock isolation cage 10 are respectively fixed to the side plates 102. Each of the shock isolation members 106 includes a main body 106a, a first shock isolation portion 106b, a second shock isolation portion 106c, and a third shock isolation portion 106d. The main body 106a of the shock isolation members 106 is fixed to the corresponding side plate 102. The first shock isolation portion 106b of the shock isolation members 106 is connected to the main body 106a, contacts a bottom surface of the electronic apparatus, and passes into the accommodating space S via the first passing portion 102a of the corresponding side plate 102. The second shock isolation portion 106c of the shock isolation members 106 is connected to the main body 106a, contacts a top surface of the electronic apparatus, and passes into the accommodating space S via the second passing portion 102b of the corresponding side plate 102. The third shock isolation portion 106d of the shock isolation members 106 is connected to the main body 106a, and passes into the accommodating space S via the third passing portion 102c of the corresponding side plate 102.

In an embodiment of the disclosure, each of the shock isolation members 106 is substantially E-shaped.

In practice, the second passing portions 102b of the side plates 102 are closed holes, and the first passing portions 102a and the third passing portions 102c of the side plates 102 can be closed holes or opened holes as needed.

In the embodiment of the disclosure, the number of the shock isolation members 106 included in the shock isolation cage 10 is four, and the numbers of the first passing portions 102a, the second passing portions 102b, and the third passing portions 102c havened by the side plates 102 are all four.

As shown in FIG. 3, the first passing portion 102a the second passing portion 102b, and the third passing portion 102c that are adjacent to each other on each of the side plates 102 are sequentially formed along a first direction A1 perpendicular to the bottom plate 100, but the disclosure is not limited in this regard.

It should be pointed out that the distance between the first shock isolation portion 106b and the second shock isolation portion 106c of each of the shock isolation member 106 is slightly smaller than the height of each of the sidewall portions 122, and the distance between the second shock isolation portion 106c and the third shock isolation portion 106d of each of the shock isolation member 106 is slightly smaller than the height of each of the sidewall portions 122. Therefore, when the carrier bracket 12 (with the storage device 14 of the server 1) is inserted into the accommodating space S, each of the sidewall portions 122 of the carrier bracket 12 is selectively clamped and fixed between the first shock isolation portion 106b and the second shock isolation portion 106c of the corresponding shock isolation member 106 (as shown in FIG. 4), or between the second shock isolation portion 106c and the third shock isolation portion 106d of the corresponding shock isolation member 106 (i.e., the upper space of the storage device 14 in FIG. 4). In other words, owing to the shock isolation members 106 disposed at the side plates 102 of the shock isolation cage 10, the embodiment of the disclosure can achieve the purpose of clamping and fixing the sidewall portions 122 of the carrier bracket 12. Hence, besides the shock isolation effect of the storage device 14 in the shock isolation cage 10 can be improved, the carrier bracket 12 can be selectively clamped and fixed between any two adjacent shock isolation portions of the shock isolation members 106, so the shock isolation cage 10 is applicable to accommodate a plurality of the stacked storage devices 14.

As shown in FIG. 2, each of the side plates 102 of the shock isolation cage 10 includes a plurality of guiding portions 102d. The guiding portions 102d of the side plates 10 are located in the accommodating space S. Each of the guiding portions 102d of the side plates 102 and the adjacent second passing portion 102b are arranged side by side along a second direction A2 parallel to the bottom plate 100. After each of the shock isolation members 106 is fixed to the corresponding side plate 102, the second shock isolation portion 106c of each of the shock isolation members 106 passes into the accommodating space S via the second passing portion 102b of the corresponding side plate 102, so each of the guiding portions 102d of the side plates 102 and the adjacent second shock isolation portion 106c are arranged side by side along the second direction A2. Thus, during the period that the carrier bracket 12 (with the storage device 14 of the server 1) is inserted into the accommodating space 5, each of the sidewall portions 122 of the carrier bracket 12 is guided by the corresponding guiding portion 102d and the corresponding second shock isolation portion 106c, so that the carrier bracket 12 moves relative to the bottom plate 100 along the second direction A2.

In an embodiment of the disclosure, each of the guiding portions 102d of the side plates 102 is substantially cylindrical, so that the smoothness of inserting the carrier bracket 12 of the server 1 into the accommodating space S can be improved.

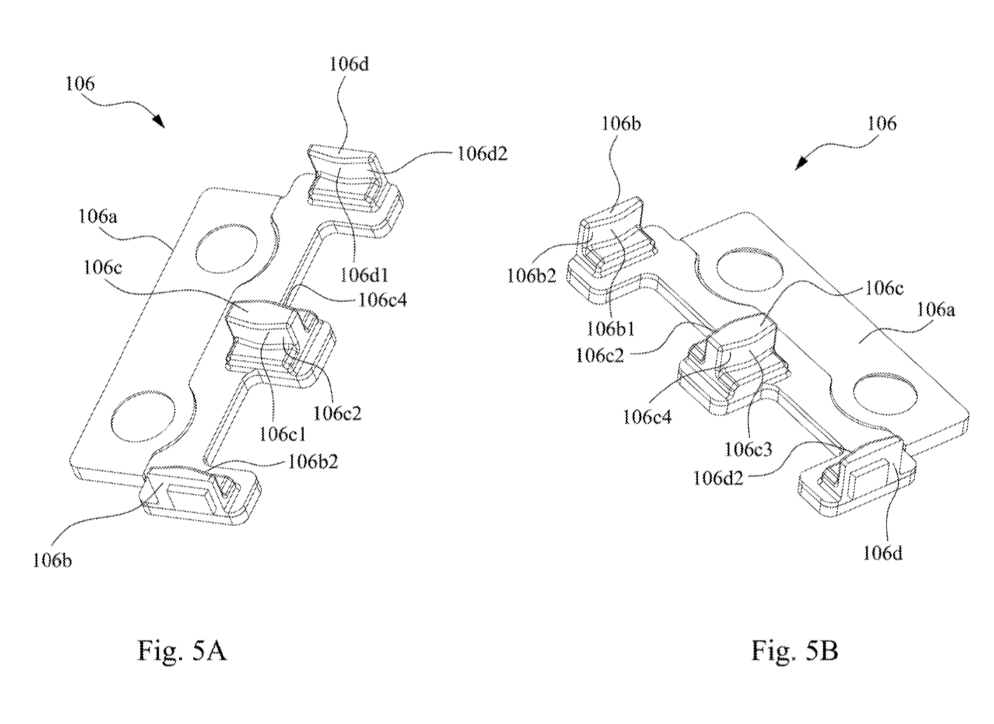

FIG. 5A is an enlarged view of one of the shock isolation members 106 in FIG. 4. FIG. 5B is another enlarged view of the shock isolation members 106 in FIG. 5.

As shown in FIG. 5A and FIG. 5B, the first shock isolation portion 106b of each of the shock isolation members 106 has a first surface 106b1 and a first chamfer 106b2. On each of the shock isolation members 106, the first surface 106b1 of the first shock isolation portion 106b faces toward the second isolation portion 106c, and the first chamfer 106b2 of the first shock isolation portion 106b is formed on the first surface 106b1 along the second direction A2. The second shock isolation portion 106b, of each of the shock isolation members 106 has a second surface 106c1, a second chamfer 106c2, a third surface 106c3, and a third chamfer 106c4. On each of the shock isolation members 106, the second surface 106c1 of the second shock isolation portion 106c faces toward the first shock isolation portion 106b, the second chamfer 106c2 of the second shock isolation portion 106c is formed on the second surface 106c1 along the second direction A2, the third surface 106c3 of the second shock isolation portion 106c faces toward the third shock isolation portion 106d, and the third chamfer 106c4 of the second shock isolation portion 106c is formed on the third surface 106c3 along the second direction A2. The third shock isolation portion 106d of each of the shock isolation members 106 has a fourth surface 106d1 and a fourth chamfer 106d2. On each of the shock isolation members 106, the fourth surface 106d1 of the third shock isolation portion 106d faces toward the second shock isolation portion 106c, and the fourth chamfer 106d2 of the third shock isolation portion 106d is formed on the fourth surface 106d1 along the second direction A2.

According to the aforementioned structural configuration, during the period that the carrier bracket 12 (with the storage device 14 of the server 1) is inserted into the accommodating space S along the second direction A2, if each of the sidewall portions 122 of the carrier bracket 12 is guided by the first chamfer 106b2 of the corresponding first shock isolation portion 106b and the second chamfer 106c2 of the corresponding second shock isolation portion 106c to pass through the corresponding first shock isolation portion 106b and the corresponding second shock isolation portion 106c, each of the sidewall portions 122 of the carrier bracket 12 is clamped and fixed between the corresponding first shock isolation portion 106b and the corresponding second shock isolation portion 106c after the carrier bracket 12 is entirely inserted into the accommodating space S. Alternatively, if each of the sidewall portions 122 of the carrier bracket 12 is guided by the third chamfer 106c4 of the corresponding second shock isolation portion 106c and the fourth chamfer 106d2 of the corresponding third shock isolation portion 106d to pass through the corresponding second shock isolation portion 106c and the corresponding third shock isolation portion 106d, each of the sidewall portions 122 of the carrier bracket 12 is clamped and fixed between the corresponding second shock isolation portion 106c and the corresponding third shock isolation portion 106d after the carrier bracket 12 is entirely inserted into the accommodating space S. In other words, during the period that the carrier bracket 12 of the server 1 is inserted into the accommodating space S of the shock isolation cage 10, the carrier bracket 12 is guided by the chamfered structures of the shock isolation portions, so that the smoothness of inserting the carrier bracket 12 into the shock isolation cage 10 can be improved.

According to the foregoing recitations of the embodiments of the disclosure, it can be seen that by using the shock isolation members disposed at two side plates of the shock isolation cage, the shock isolation cage of the disclosure can achieve the purpose of clamping and fixing the sidewall portions of the carrier bracket. Hence, the vibration isolation effect of the storage devices in the shock isolation cage can be improved. That is, the possibility that the performance of the storage device is worsened by the collisions among the rack and the carrier bracket under the vibration environment can be reduced, and the situation that the storage device is seriously damaged by impacts can be avoided. In addition, the shock isolation cage of the disclosure includes at least three shock isolation portions, and the carrier bracket can be selectively clamped and fixed between any two adjacent shock isolation portions, so that the shock isolation cage is applicable to accommodate a plurality of the stacked storage devices. Moreover, each of the shock isolation portions has a chamfered structure, so that the carrier bracket is guided by the chamfered structures of the shock isolation portions during the period that the carrier bracket is inserted into the shock isolation cage, and thus the smoothness of inserting the carrier bracket into the shock isolation cage can be increased.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A shock isolation cage for accommodating an electronic apparatus, the shock isolation cage comprising:
a bottom plate;
two side plates fixed to the bottom plate;
a top plate fixed to the side plates to make the side plates be located between the bottom plate and the top plate, wherein the bottom plate, the side plates, and the top plate surround to form an accommodating space; and
two shock isolation members respectively fixed to the side plates, each of the shock isolation members comprising:
a main body fixed to the corresponding side plate;
a first shock isolation portion connected to the main body and capable of contacting a bottom surface of the electronic apparatus; and
a second shock isolation portion connected to the main body and capable of contacting a top surface of the electronic apparatus.

2. The shock isolation cage of claim 1, wherein the electronic apparatus comprises a carrier bracket, the carrier bracket comprises two sidewall portions, each of the side plates has a first passing portion and a second passing portion, the first and second shock isolation portions pass into the accommodating space respectively via the corresponding first and second passing portions, and when the carrier bracket is inserted into the accommodating space, each of sidewall portions of the carrier bracket is clamped and fixed between the corresponding first and second shock isolation portions.

3. The shock isolation cage of claim 2, wherein the first and second passing portions of each of the side plates are formed along a first direction away from the bottom plate.

4. The shock isolation cage of claim 3, wherein the first shock isolation portion has a first surface and a first chamfer, the first surface faces toward the second isolation portion, the first chamfer is formed on the first surface along a second direction parallel to the bottom plate, the second shock isolation portion has a second surface and a second chamfer, the second surface faces toward the first shock isolation portion, the second chamfer is formed on the second surface along the second direction, and during the period that the carrier bracket is inserted into the accommodating space along the second direction, each of the sidewall portions is guided by the corresponding first and second chamfers to pass through the corresponding first and second shock isolation portions.

5. The shock isolation cage of claim 3, wherein each of the side plates further has a third passing portion, the first passing portion, the second passing portion, and the third passing portion of each of the side plates are sequentially formed along the first direction each of the shock isolation members further comprises a third shock isolation portion, the third shock isolation portion is connected to the main body and passes into the accommodating space via the corresponding third passing portion, and when the carrier bracket is inserted into the accommodating space, each of the sidewall portions is selectively clamped and fixed between the corresponding first and second shock isolation portions, or between the corresponding second and third shock isolation portions.

6. The shock isolation cage of claim 5, wherein each of the side plates comprises at least one guiding portion located in the accommodating space, each of the guiding portions and the adjacent second shock isolation portion are arranged side by side along a second direction parallel to the bottom plate, and during the period that the carrier bracket is inserted into the accommodating space, each of the sidewall portions is guided by the corresponding guiding portion and the corresponding second shock isolation portion, so that the carrier bracket moves relative to the bottom plate along the second direction.

7. The shock isolation cage of claim 6, wherein each of the guiding portions is substantially cylindrical.

8. The shock isolation cage of claim 5, wherein the first shock isolation portion has a first surface and a first chamfer, the first surface faces toward the second shock isolation portion, the first chamfer is formed on the first surface along a second direction parallel to the bottom plate, the second shock isolation portion has a second surface, a second chamfer, a third surface and a third chamfer, the second surface faces toward the first shock isolation portion, the second chamfer is formed on the second surface along the second direction, the third surface faces toward the third shock isolation portion, the third chamfer is formed on the third surface along the second direction, the third shock isolation portion has a fourth surface and a fourth chamfer, the fourth surface faces toward the second shock isolation portion, the fourth chamfer is formed on the fourth surface along the second direction, and during the period that the carrier bracket is inserted into the accommodating space along the second direction, each of the sidewall portions is selectively guided by the corresponding first and second chamfers to pass through the corresponding first and second shock isolation portions, or is guided by the corresponding third and fourth chamfers to pass through the corresponding second and third shock isolation portions.

9. The shock isolation cage of claim 5, wherein the shock isolation member is substantially E-shaped.
